(19) United States
(12) Patent Application Publication
(10) Pub. No.: US 2025/0144979 A1
(43) Pub. Date: May 8, 2025

(54) AIR GUIDE ELEMENT FOR A VENTILATION NOZZLE

(71) Applicant: MERCEDES-BENZ GROUP AG, Stuttgart (DE)

(72) Inventors: Volker GERHARDT, Schönaich (DE); Alexander OHM, Greppen (CH); Felix HEINRICH, München (DE); Harald WOLF, Ammerbuch (DE)

(21) Appl. No.: 18/684,349

(22) PCT Filed: Jul. 21, 2022
(86) PCT No.: PCT/EP2022/070527

§ 371 Date: Feb. 16, 2024

(30) Foreign Application Priority Data
Aug. 17, 2021 (DE) 10 2021 004 197.6

(51) Int. Cl. B60H 1/34; B60Q 3/20

(52) U.S. Cl. CPC B60H 1/3407; B60Q 3/20

(57) ABSTRACT

An air guide element for a ventilation nozzle in a motor vehicle includes a main body at least partially enclosing the cross-section of the ventilation nozzle and on which air guiding fins are arranged. The air guide element also includes a lighting device. The main body and the air guiding fins are produced as a single piece by multi-component 3D printing. The main body has a transparent core. Portions of the surface of the main body and the air guiding fins are printed onto the core at least partially from a semi-transparent material and at least partially from an opaque material.

### BACKGROUND AND SUMMARY OF THE INVENTION

Exemplary embodiments of the invention relate to an air guide element, for example an air guide ring, for a ventilation nozzle in a motor vehicle, as well as to a ventilation nozzle with such an air guide element.

A ventilation device is known from DE 10 2014 018 302 A1, in which an air guide element is provided for diverting the air flow at a specific angle to the housing of the ventilation nozzle. In this case, a part of this air guide element can be illuminated by a light guide. The design is such that movement between two light-guiding elements is provided, which makes the device relatively complex to produce and in particular relatively prone to errors.

DE 10 2014 015 252 A1 describes a further ventilation device, in which, in particular, an adjusting element for the air guide elements is designed to be illuminated.

Furthermore, DE 10 2008 047 833 A1 can be referred to as further prior art, which describes the structure of a plastic molded body constructed partly from plastic that can be galvanized and partly from plastic that cannot be galvanized, in order to enable surface coating by means of galvanization, targeted in specific regions.

Exemplary embodiments of the present invention are directed to an air guide element for a ventilation nozzle in a motor vehicle, which element is designed to be illuminated, wherein the construction of the design is simplified and the design possibilities are expanded compared to the prior art.

The air guide element according to the invention has a main body enclosing the ventilation nozzle in cross section, i.e., a main body surrounding or enclosing the ventilation nozzle completely or mostly around its circumference. With a ventilation nozzle with a round cross section, as is frequently the case in practice, the air guide element would then be realized according to a particularly favorable embodiment of the invention as an air guide ring. Air guiding fins are arranged on the main body and the air guide element is provided with a lighting device.

According to the invention, the main body and the air guiding fins, and thus the entire air guide element with the exception of the lighting device are produced as single piece by means of multi-component 3D printing. This is extraordinarily simple and efficient to produce. Different types of components can be joined together to form a single one-piece component, such that the main body of the air guide element according to the invention has a transparent core, wherein parts of the surface of the main body and the air guiding fins are printed onto the core-formed from transparent material-partially from semi-transparent material and partially from non-transparent material. This one-piece construction, available in multi-material 3D printing, can be realized with the transparent core as a light guide. The printing of the surface and/or of the air guiding fins or their surfaces partially from transparent and partially from opaque material then makes it extremely easy and efficient to realize the desired design, for example to place luminous air guiding fins on a non-luminous surface of the main body or vice versa.

Further parts of the main body can then similarly be overprinted with semi-transparent or opaque material, in order to illuminate or also not illuminate these parts, depending on the design requirements when the lighting device is active.

An extraordinarily favorable development of the air guide element according to the invention provides that the opaque materials or semi-transparent materials, or also both, that are applied onto the transparent core are colored. This allows the design to be further optimized with a color scheme, for example by making individual surfaces a color that is transparent when illuminated and other surfaces opaque and colored directly, with no light penetrating here when illuminated.

A further extraordinarily favorable embodiment of the air guide element according to the invention further provides that the core is formed from two arms converging at an acute angle and between which a hollow space or cavity is formed, wherein the lighting device injects light into the arms and/or the hollow space from the side facing away from the acute angle. The structure can, for example, be formed in the manner of an inverted V. In this case, the central axis of this V can be straight or also inclined or curved. A hollow space is created between the two arms of the transparent material of the core which form and are connected at one of their ends. When light is injected into the side facing away from the connected part, which could also be referred to as the tip, of the arms, this ensures that the injected light reaches the area of the arms over a large area and is efficiently emitted from these arms in the areas where the core is printed with the semi-transparent material.

An extraordinarily favorable design of the air guide element according to the invention provides that the air guiding fins are printed from the opaque material. These are therefore not permeable to light and can be made of black-colored material, for example. A further very advantageous idea, which can in particular be combined with this embodiment, also provides that the surfaces of the main body that are located between the light guiding fins are printed from the transparent material. These surfaces can, for example, be printed from the transparent material in a contrasting color, for example in white. If the lighting device is switched on and light is injected into the transparent core, then the light can be emitted in the area of these surfaces located between the air guiding fins, so that these surfaces are illuminated, whilst the air guiding fins, according to the above-described advantageous embodiment, themselves, in particular, remain unilluminated and thus are only illuminated indirectly via the surfaces located between them.

A further very advantageous embodiment, which can, but not necessarily, be combined again with the two previously described embodiments, provides that all surfaces of the main body that are not located between the air guiding fins are printed with the opaque material. The result of this, in particular in combination with the above-described embodiment, is that illumination is only provided in the region between the individual air guiding fins and not in a region surrounding them, for example an outer and/or inner ring segment or similar encompassing them.

According to a further very favorable embodiment of the air guide element according to the invention, it can further be provided that the main body with the air guiding fins is vapor-deposited with a translucent metal layer on its surface, and here, in particular, on its surface later facing towards a vehicle interior. Such a metal layer can be a thin layer of aluminum, for example, which is vapor-deposited onto the main body and the air guiding fins. This creates the appearance of a chrome-plated component, which looks like a chrome-plated air guide element or air guide ring, when the lighting devices are not switched on. If the lighting device is activated, then the illumination shines through in those regions where the main body and/or the air guiding fins are printed with semi-transparent material. This makes it possible to create both a very attractive daytime design when the lighting device is not activated, as well as a very attractive night-time design when the lighting device is activated.

A further very advantageous development of the air guide element according to the invention can, as already explained above, provide that this is formed as an air guide ring.

An advantageous development of the air guide element or air guide ring further provides that the lighting device is formed as an LED ring. This embodiment using LEDs, in particular in the form of an LED ring, preferably with the annular embodiment of the air guide element as an air guide ring, enables very simple and efficient illumination. The lighting device itself is therefore part of the air guide element and moves correspondingly with this, such that no moving transmission of light from one light guide to the other light guide is necessary, but that the lighting device can be fixedly connected with the main body in order to inject the light in the way and manner already discussed above. The lighting device then moves with the air guide element such that only a flexible electric power supply is required for the lighting device.

Illumination via light-emitting diodes has the additional advantage that it is very energy-saving, can be implemented in a very small installation space and that it is relatively easy to produce light in different colors. This makes it possible, for example, to implement different colors of light via the lighting device. This allows the design of the air guide element, and here in particular the color of its illumination, to be integrated into a color concept for ambient interior lighting in the vehicle. In addition, or alternatively, functional displays are possible, for example a red hue when warm air is flowing out of the ventilation nozzle or a blue hue when cool air is flowing out of the ventilation nozzle.

Alternatively, a single light color can also be realized, which for example, supplemented by the coloring of the semi-transparent material, emits the desired light color into the interior as a static lighting color.

A lighting nozzle for a motor vehicle with such a light-guiding element can now provide for the latter to be formed as a light-guiding ring and to close off the ventilation nozzle in the direction of a vehicle interior. The air guide element or the air guide ring thus forms the end of the ventilation nozzle on the side facing the vehicle interior such that here the design, which can be adjusted very flexibly over wide stretches with the design according to the invention of the air guide element, comes into its own.

The air guide element itself can therefore be printed very cost-effectively as a one-piece component. Multi-component printing from different transparent, semi-transparent, opaque, and/or colored materials enables an extraordinarily diverse and flexible design. In particular, the air guiding fins can include colored, semi-transparent and illuminated areas as well as colored, opaque areas, in order to be able to flexibly adapt the design both in the illuminated and unilluminated state via the air guiding fins and/or the surfaces located between them.

Further advantageous embodiments of the air guide element according to the invention and of the ventilation nozzle also result from the exemplary embodiment which is presented in more detail below with reference to the figures.

### BRIEF DESCRIPTION OF THE DRAWING FIGURES

Shown here are:

FIG. 1 a top view of a possible embodiment of the air guide element in the form of an air guide ring;

FIG. 2 a schematic sectional view according to the line II-II in FIG. 1; and

FIG. 3 an exemplary ventilation nozzle with the air guide element according to FIG. 1.

### DETAILED DESCRIPTION

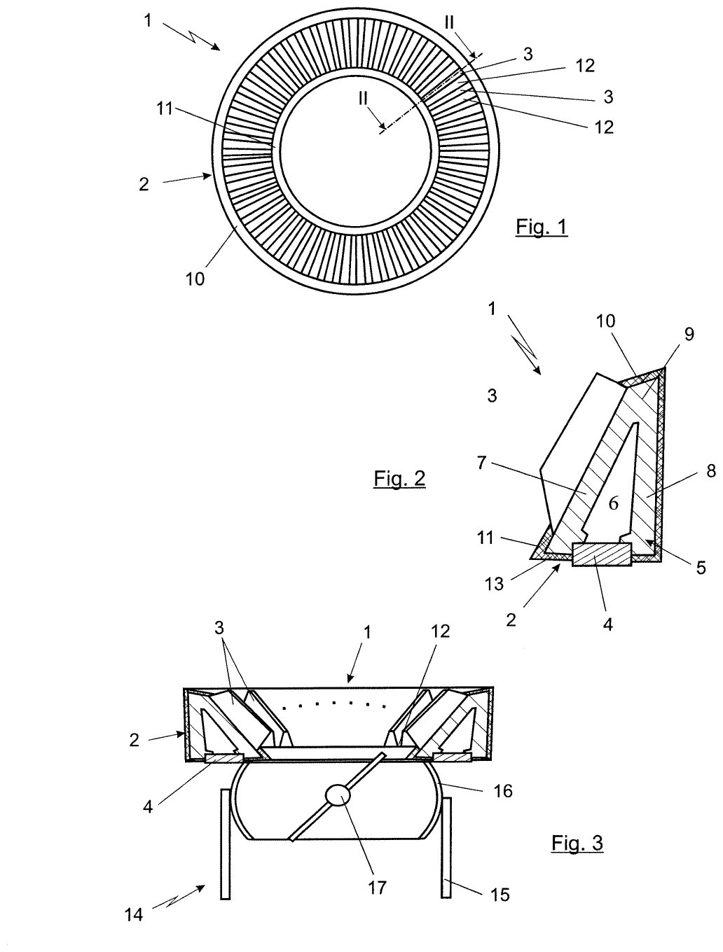

FIG. 1 illustrates a top view of an air guide element 1 in the form of an air guide ring 1. This essentially consists of a main body, which can be seen in cross section in FIG. 2, with a number of air guiding fins 3 distributed around the circumference, as well as a lighting device 4, which, in particular, is formed as an LED ring. The main body 2 together with the air guiding fins 3 is now produced as a single-piece component by multi-component 3D printing from different materials.

The main body 2 itself comprises a core 5 made of a transparent material, which encloses a cavity 6 or a hollow space 6 between two arms 7, 8. These two arms 7, 8 are connected with each other in the region of a tip labelled 9. This tip is designed in the structure according to the invention in such a way that the two arms 7, 8 converge as a single piece in the core 5. It does not necessarily have to be a tip, but can, as can be seen in the sectional illustration of FIG. 2, comprise an annular region 10 in the top view according to FIG. 1, which can be referred to as an outer ring segment of the air guide ring 1. The air guiding fins labelled 3 extend between this outer ring segment 10 and an inner ring segment 11, and, as can again be seen in the illustration in FIG. 1, respective interspaces labelled 12 extend between said air guiding fins.

In the illustration of FIG. 1, only a few of these air guiding fins 3 and interspaces 12 between these air guiding fins 3 are provided with reference numerals. The construction of alternating air guiding fins 3 and interspaces 12 continues in practice however, over the entire circumference of the air guide element 1, as is represented in FIG. 1. The cavity 6 now works together with the lighting device 4 in such a way that light is injected into the two arms 7, 8 of the core 5 and/or into the cavity 6. As a result, an ideal light distribution is achieved, as the light absorption inside of the core 5 is clearly reduced by the cavity 6 arranged in the core 5 and thus the illumination is improved.

The aforementioned multi-component 3D printing, which is used for the single-piece production of the main body 2 together with its air guiding fins 3, now uses different materials or components. In the region of the core 5, this is a transparent material, so that the core 5 distributes the light of the lighting device 4 equally over the entire circumference and the entire surface of the main body 2. The latter would now light up all over, as the light is emitted equally on all surfaces. In order to prevent this, a coat of opaque material is now printed onto the core 5 in sections. In the illustration in FIG. 2, this opaque material is labelled 13. It surrounds a large part of the core 5 and is represented in the illustration in FIG. 2 with cross-hatching. This material can, for example, consist of a black opaque plastic that is printed onto the transparent material of the core 5. The air guiding fins 3 can now be entirely or at least partially realized from the same opaque material. In the exemplary embodiment represented here, they should consist entirely of this opaque material.

Transparent or partially transparent materials can now be used in the region of the interspaces 12 seen in FIG. 1, which are located both between the individual air guiding fins 3 and also between the two ring segments 10, 11, which segments are all printed onto the core 5 with opaque material. In particular, white-colored partially transparent materials should be printed onto the core 5 in the region of the interspaces 12. The design of the air guide element 1 then consists of an alternating black-white image in the region of the interspaces 12 and air guiding fins 3, as well as two black ring segments 10, 11 surrounding these. In the case of illumination, these interspaces 12 can now be illuminated by the lighting device 4. The desired design is created according to the injected light color of the lighting device 4. In the daytime design, i.e., with the light switched off, in comparison to the night-time design, the color of the opaque and transparent materials comes into effect.

In addition to the described color scheme, it is now possible to provide the entire surface of the main body 2 together with its air guiding fins 3 with a translucent metal layer. Such a metal layer can, for example, be a vapor-deposited aluminum layer. This then ensures a chrome-plated appearance of the air guiding ring 1 with the lighting switched off, i.e., in the daytime design. If, by contrast, the lighting is switched on, then the interspaces 12 shine brightly through the metallic coating in the region of the air guiding fins 3 and of the ring segments 10, 11, and the dark material behind the metallic layer then essentially comes into its own, such that a chrome-plated daytime design can be simply combined with an illuminated night-time design.

The entire structure, which is only schematically indicated here with regards to its shape, can therefore be realized in different ways. For example, a central axis, which runs centrally in the cavity 6 from bottom to top, could be sloped at a larger angle towards the horizontal in the illustration in FIG. 2 than is shown here. Rather than a straight line, here any curve or similar could also be used, meaning that the core 5 could then, for example, be realized in a curved manner.

In the illustration in FIG. 3, the air guiding ring 1 is again shown in a schematic sectional view analogous to that in FIG. 2 but with a section over the entire diameter. The individual air guiding fins 3 are not all explicitly shown here, rather only individual air guiding fins 3, as well as the interspaces 12 arranged therebetween are indicated. The air guiding ring 1 is now mounted on a ventilation nozzle 14, which, in a manner known per se, consists of a housing or tube 15 in which a spherical-dome-shaped element 16 is arranged in a movable manner so that the latter can be adjusted in order to steer the air flow discharged via the ventilation nozzle 14 in a desired direction. Furthermore, a device can be provided for regulating the through flow, which is indicated here schematically in the manner of a throttle valve 17. The air guiding ring 1 together with its lighting device 4 is now mounted on this movable element 16. This makes it possible to use the air guide ring 1 and its air guiding fins 3 to generate the desired direction in an air flow by adjusting the movable element 16 and to guide the air flow effectively via the air guiding fins 3 so that it flows through the vehicle interior in the desired manner and thus, for example, warms or cools a person as desired. The air guide ring 1 forms the preferably annular end of the ventilation nozzle 14 in relation to the vehicle interior, which would therefore be above the illustration in FIG. 3. Instead of a ring, other shapes are of course conceivable, for example an oval, a rectangle, a square, an octagon, a hexagon or even an irregular shape, which can, for example, only cover part of the circumference, the tube 15 or the element 16.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. An air guide element for a ventilation nozzle in a motor vehicle, the air guide element comprising:
a main body at least partially enclosing a cross-section of the ventilation nozzle;
air guiding fins arranged on the main body; and
a lighting device,
wherein the main body and the air guiding fins are produced as a single piece by multi-component 3D printing,
wherein the main body has a transparent core,
wherein parts of a surface of the main body and the air guiding fins are printed onto the transparent core at least partially from a semi-transparent material and at least partially from an opaque material.

12. The air guide element of claim 11, wherein the opaque materials or semi-transparent materials printed onto the transparent core are colored.

13. The air guide element of claim 11, wherein the transparent core, as viewed in cross-section, is formed from two arms converging at an acute angle and between which a cavity is formed, wherein the lighting device injects light into the arms or the cavity from the side facing away from the acute angle.

14. The air guide element of claim 11, wherein the air guiding fins are printed from the opaque material.

15. The air guide element of claim 11, wherein surfaces of the main body located between the air guiding fins are printed from the semi-transparent material.

16. The air guide element of claim 11, wherein all surfaces of the main body that are not located between the air guiding fins are printed with the opaque material.

17. The air guide element of claim 11, wherein the main body with the air guiding fins is vapor-deposited with a translucent metal layer on at least a part of its surface.

18. The air guide element of claim 11, wherein the main body is annular.

19. The air guide element of claim 11, wherein the lighting device is an LED arrangement with a shape corresponding to the main body.

20. A ventilation nozzle for a motor vehicle, the ventilation nozzle comprising:
an air guide element formed as an air guide ring, wherein the air guide element comprises
a main body at least partially enclosing a cross-section of the ventilation nozzle;
air guiding fins arranged on the main body; and
a lighting device,
wherein the main body and the air guiding fins are produced as a single piece by multi-component 3D printing,
wherein the main body has a transparent core, and
wherein parts of a surface of the main body and the air guiding fins are printed onto the transparent core at least partially from a semi-transparent material and at least partially from an opaque material, and
wherein the air guide element closes off the ventilation nozzle in a direction of a vehicle interior.

21. A method for forming an air guide element for a ventilation nozzle in a motor vehicle, the method comprising:
producing, by multi-component 3D printing, a main body and air guiding fins as a single piece, wherein the main body at least partially encloses a cross-section of the ventilation nozzle and wherein the air guiding fins arranged on the main body; and
affixing a lighting device to the main body,
wherein the main body has a transparent core,
wherein parts of a surface of the main body and the air guiding fins are printed onto the transparent core at least partially from a semi-transparent material and at least partially from an opaque material.

22. The method of claim 21, wherein the opaque materials or semi-transparent materials printed onto the transparent core are colored.

23. The method of claim 21, wherein the transparent core, as viewed in cross-section, is formed from two arms converging at an acute angle and between which a cavity is formed, wherein the lighting device injects light into the arms or the cavity from the side facing away from the acute angle.

24. The method of claim 21, wherein the air guiding fins are printed from the opaque material.

25. The method of claim 21, wherein surfaces of the main body located between the air guiding fins are printed from the semi-transparent material.

26. The method of claim 21, wherein all surfaces of the main body that are not located between the air guiding fins are printed with the opaque material.

27. The method of claim 21, wherein the main body with the air guiding fins is vapor-deposited with a translucent metal layer on at least a part of its surface.

28. The method of claim 21, wherein the main body is annular.

29. The method of claim 21, wherein the lighting device is an LED arrangement with a shape corresponding to the main body.
